(19) United States
(12) Patent Application Publication
(10) Pub. No.: US 2025/0247816 A1
(43) Pub. Date: Jul. 31, 2025

(54) HYBRID DELTA CARRIER PHASE POSITIONING

(71) Applicant: QUALCOMM INCORPORATED, San Diego, CA (US)

(72) Inventors: Min WANG, Tustin, CA (US); Ning LUO, Cupertino, CA (US); Yinghua YANG, San Jose, CA (US); Furqan Ahmed, Eastvale, CA (US); Satya Swaroop YADATI, Bangalore (IN); Utkarsh SINHA, Bangalore (IN)

(21) Appl. No.: 18/426,751

(22) Filed: Jan. 30, 2024

(51) Int. Cl. H04W 64/00; H04L 5/00

(52) U.S. Cl. CPC H04W 64/003; H04L 5/0048

(57) ABSTRACT

A method, for estimating position of an apparatus, includes: determining an initial carrier phase measurement for each of a plurality of initial satellite signals received by the apparatus; determining a subsequent carrier phase measurement for each of at least one subsequent satellite signal received by the apparatus; storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band; removing, from each subsequent carrier phase measurement that corresponds to one of the combinations of satellite and frequency band, a corresponding one of the set of ambiguities to produce a set of ambiguity-removed carrier phase measurements; and determining an estimate of position of the apparatus based on the set of ambiguity-removed carrier phase measurements.

### BACKGROUND

Obtaining the locations of mobile devices may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points.

Positions of devices, such as mobile devices, may be determined using terrestrial-based positioning signals and/or satellite positioning signals. Satellite positioning system receivers may be included in various devices (e.g., smartphones, tablet computers, vehicles (e.g., cars, unoccupied aerial vehicles, etc.), etc.) for receiving and measuring satellite positioning signals. Measurements of the satellite positioning signals may be processed to determine position information, such as ranges between satellites and the receiver and/or a position estimate for the receiver.

### SUMMARY

An example apparatus includes: at least one receiver configured to transduce wireless signals into guided signals; at least one memory; at least one processor, communicatively coupled to the at least one receiver and the at least one memory, configured to: determine an initial carrier phase measurement for each of a plurality of initial satellite signals received by the at least one receiver; determine a subsequent carrier phase measurement for each of at least one subsequent satellite signal received by the at least one receiver; store a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band; remove, from each subsequent carrier phase measurement that corresponds to one of the combinations of satellite and frequency band, a corresponding one of the set of ambiguities to produce a set of ambiguity-removed carrier phase measurements; and determine an estimate of position of the apparatus based on the set of ambiguity-removed carrier phase measurements.

An example method, for estimating position of an apparatus, includes: determining an initial carrier phase measurement for each of a plurality of initial satellite signals received by the apparatus; determining a subsequent carrier phase measurement for each of at least one subsequent satellite signal received by the apparatus; storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band; removing, from each subsequent carrier phase measurement that corresponds to one of the combinations of satellite and frequency band, a corresponding one of the set of ambiguities to produce a set of ambiguity-removed carrier phase measurements; and determining an estimate of position of the apparatus based on the set of ambiguity-removed carrier phase measurements.

Another example apparatus includes: means for determining an initial carrier phase measurement for each of a plurality of initial satellite signals received by the apparatus; means for determining a subsequent carrier phase measurement for each of at least one subsequent satellite signal received by the apparatus; means for storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band; means for removing, from each subsequent carrier phase measurement that corresponds to one of the combinations of satellite and frequency band, a corresponding one of the set of ambiguities to produce a set of ambiguity-removed carrier phase measurements; and means for determining an estimate of position of the apparatus based on the set of ambiguity-removed carrier phase measurements.

An example non-transitory, processor-readable storage medium includes processor-readable instructions to cause a processor of an apparatus to: determine an initial carrier phase measurement for each of a plurality of initial satellite signals received by the apparatus; determine a subsequent carrier phase measurement for each of at least one subsequent satellite signal received by the apparatus; store a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band; remove, from each subsequent carrier phase measurement that corresponds to one of the combinations of satellite and frequency band, a corresponding one of the set of ambiguities to produce a set of ambiguity-removed carrier phase measurements; and determine an estimate of position of the apparatus based on the set of ambiguity-removed carrier phase measurements.

### BRIEF DESCRIPTION OF THE DRAWINGS

FIG. 1 is a simplified diagram of a navigation environment.

FIG. 2 is a block diagram of components of an example device shown in FIG. 1.

FIG. 3 is a processing and data flow for hybrid delta carrier phase techniques for positioning a mobile device.

FIG. 4 is a block flow diagram of a method for estimating position of an apparatus.

### DETAILED DESCRIPTION

Techniques are discussed herein for determining position of a mobile device. For example, a hybrid approach to delta carrier phase measurements may be used to determine a location estimate (also called a position estimate, a location, or a position) of a mobile device. An initial or seed position (e.g., as part of an initial or seed position/velocity/time (PVT) determination) may be used to determine a float carrier phase ambiguity for each of multiple satellite vehicles. The float ambiguities may be removed from later carrier phase measurements for the respective satellite vehicles. The ambiguity-removed carrier phase measurements may be used to determine an ambiguity-removed position/velocity/time determination. The ambiguity-removed position/velocity/time determination may be used to determine ambiguities corresponding to satellite vehicles for which ambiguities have not previously been stored, and these new ambiguities may be used to determine new ambiguity-removed carrier phase measurements, which may be used to determine a new ambiguity-removed position/velocity/time determination, etc. Other techniques and/or configurations may be used.

Items and/or techniques described herein may provide one or more of the following capabilities, as well as other capabilities not mentioned. Position of a mobile device may be determined using delta carrier phase measurements even where signals from an insufficient quantity (e.g., zero) of satellite vehicles from which a position was initially determined are available, e.g., avoiding loss of position determination associated with a direct delta approach of delta carrier phase measurement position determination. Position of a mobile device may be determined using delta carrier phase measurements while mitigating effects of accumulated errors, e.g., mitigating errors associated with an accumulated delta approach to delta carrier phase measurement position determination. Other capabilities may be provided and not every implementation according to the disclosure must provide any, let alone all, of the capabilities discussed.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

A positioning device may be any of a variety of devices (e.g., a mobile phone, tablet computer, laptop computer, consumer asset tracking device, Internet of Things (IoT) device, etc.) used to determine a position of the device. Positioning devices may be embodied by any of a number of types of devices including but not limited to printed circuit (PC) cards, compact flash devices, external or internal modems, wireless or wireline phones, smartphones, tablets, consumer asset tracking devices, asset tags, and so on.

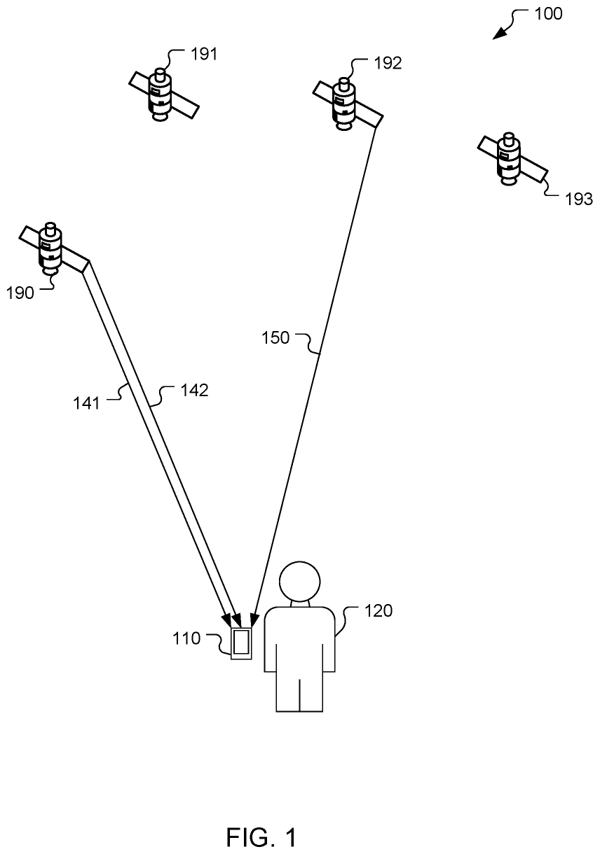

Referring to FIG. 1, in a navigation environment 100, a mobile device 110 associated with (e.g., held by) a user 120 may receive satellite signals from satellites 190-193. The satellites 190-193 are members of a satellite constellation, i.e., a group of satellites that are part of a system, e.g., controlled by a common entity such as a government, and orbiting in complementary orbits to facilitate determining positions of entities around the world. The satellites 190-193 may be, for example, members of the GPS, Galileo, Beidou, GLONASS, or QZSS constellation. The satellites 190-193 may each transmit multiple satellite signals in one or more frequency bands. For example, the satellite 190 may transmit satellite signals 141, 142 that have frequencies in different frequency bands, e.g., L1 and L2/L5 frequency bands, the satellites 191 and 193 may transmit signals in the same frequency bands (not shown), and a satellite signal 150 from the satellite 192 may have a frequency in only one frequency band, e.g., the L1 frequency band.

Numerous implementations and variations of the environment 100 are possible. For example, although one mobile device 110 (e.g., a user equipment (UE)) is illustrated, many mobile devices (e.g., hundreds, thousands, millions, etc.) may be present in the environment 100. The environment 100 may include a other quantities of SVs (i.e., more or fewer than the four SVs 190-193 shown), including multiple constellations of SVs.

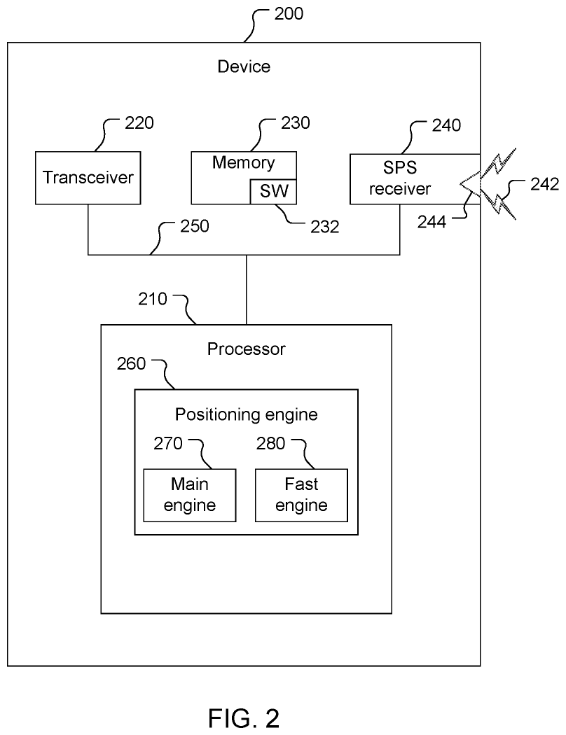

Referring also to FIG. 2, a device 200 may be an example of the mobile device 110 and may comprise a computing platform including a processor 210, a transceiver 220, memory 230, and a Satellite Positioning System (SPS) receiver 240, all communicatively coupled to each other by a bus 250 (which may be configured, e.g., for optical and/or electrical communication). One or more of the shown apparatus (e.g., the transceiver 220) may be omitted from the device 200 and/or one or more other apparatus (e.g., one or more sensors, one or more cameras, etc.) that are not shown in FIG. 2 may be included in the device 200. The processor 210 may include one or more hardware devices, e.g., a central processing unit (CPU), a microcontroller, and/or an application specific integrated circuit (ASIC). The processor 210 may comprise multiple processors including one or more of a general-purpose/application processor, a Digital Signal Processor (DSP), a modem processor, a video processor, and/or a sensor processor. The memory 230 may be a non-transitory storage medium that may include random access memory (RAM), flash memory, disc memory, and/or read-only memory (ROM), etc. The memory 230 may store software 232 which may be processor-readable, processor-executable software code containing instructions that may be configured to, when executed, cause the processor 210 to perform various functions described herein. Alternatively, the software 232 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the device 200 performing a function as shorthand for one or more appropriate components of the device 200 performing the function. The processor 210 may include a memory with stored instructions in addition to and/or instead of the memory 230. Functionality of the processor 210 is discussed more fully below. The configuration of the device 200 shown in FIG. 2 is an example and not limiting of the disclosure, including the claims, and other configurations may be used. Even if referred to in the singular, the processor 210 may include more than one processor, the transceiver 220 may include more than one transceiver, and/or the memory 230 may include more than one memory (e.g., the device 200 may include at least one processor, at least one transceiver, and/or at least one memory).

The transceiver 220 may be configured to communication with one or more other devices. For example, the transceiver 220 may include a wireless transceiver and antenna, and/or a wired transceiver configured to communicate with other devices through wireless connections and wired connections, respectively. For example, the wireless transceiver may include a wireless transmitter and a wireless receiver coupled to an antenna for transmitting and/or receiving wireless signals and transducing signals between wireless signals and guided (e.g., wired (e.g., electrical and/or optical)) signals. The wireless transmitter may include appropriate components (e.g., a power amplifier and a digital-to-analog converter). The wireless receiver may include appropriate components (e.g., one or more amplifiers, one or more frequency filters, and an analog-to-digital converter). The wireless transmitter, the wireless receiver, and/or the antenna may include multiple transmitters, multiple receivers, and/or multiple antennas, respectively, for sending and/or receiving, respectively, appropriate signals.

The SPS receiver 240 (e.g., a Global Positioning System (GPS) receiver) may be capable of receiving and acquiring SPS signals 242 via an SPS antenna 244. The SPS antenna 244 is configured to transduce between the SPS signals 242, which are wireless signals, and guided signals, e.g., wired signals such as electrical or optical signals. The SPS receiver 240 may be configured to process, in whole or in part, the SPS signals 242 for estimating a location of the device 200. For example, the SPS receiver 240 may be configured to determine location of the device 200 by trilateration using the SPS signals 242. The memory 230 may store indications (e.g., measurements) of the SPS signals 242 for use in performing positioning operations.

SPS receiver clock estimates may be obtained using various techniques/models. For example, in an SPS receiver clock modeling method, a primary signal (e.g., GPS L1 C/A) is selected to map to a primary receiver clock term. Other signals may be mapped to the primary receiver clock term and an ISTB (Inter/Intra System/Signal Time Bias). As another example, a precise positioning engine (PPE) and/or RTK engine may be used to determine precise receiver clock estimations. A reference SV may be selected and a differential between SVs determined to remove a receiver clock term from consideration. A PPE may estimate a receiver clock with or without double-differencing.

The processor 210 may be utilized to process SPS signals 242, in whole or in part, to calculate an estimated location of the device 200. For example, the processor 210 (possibly in combination with the memory 230, e.g., the software 232) may implement a positioning engine 260. The positioning engine 260 may be configured to perform one or more functions to calculate an estimated location (also called a location estimate, or simply a location) of the device 200. The positioning engine 260 may use a Satellite Positioning System (SPS) (a Global Navigation Satellite System (GNSS)), e.g., the SPS receiver 240, for high-accuracy positioning using precise point positioning (PPP) or real time kinematic (RTK) technology. The positioning engine 260 is discussed further below, and the description may refer to the processor 210 generally, or the device 200 generally, as performing any of the functions of the positioning engine 260, with the device 200 being configured to perform the function(s). While the discussion herein focuses on the device 200, functions discussed as being performed by the device 200 may also or alternatively be performed by another apparatus (e.g., a base station).

Highly accurate estimation of a position of a device is often desirable, or even required. Various techniques may be used to provide highly-accurate position estimates. For example, PPP and/or RTK may be used to determine centimeter-level position estimates. In order to achieve such accuracies, precise receiver clock estimations are determined. Multiple SV signals are received and measured and each SV signal has a corresponding receiver clock term. Base correction may be used to remove multiple error sources including satellite clock error. Satellite vehicles have very precise clock and stay biased with respect to each other by fixed amounts that can be obtained such that once one clock term is determined, the clock terms for other SVs may be determined.

Techniques, called delta carrier phase (DCP) techniques, using differences in carrier phase measurements between different times have been used to determine mobile device position. Such techniques have provided low-latency solutions for higher rate (e.g., 10 Hz, 20 Hz, or higher) for high-dynamic applications (e.g., automobiles, unoccupied aerial vehicles (UAVs), etc.). A complex PPE (Precise Positioning Engine) may be used with a large EKF (Enhanced Kalman Filter) may be used to implement such techniques, including ambiguity term estimation (i.e., an estimation of the ambiguous number of cycles of a carrier phase between a transmitting SV and a receiving mobile device). Such a PPE may run at a low rate (e.g., 1 Hz) and/or with a high latency in order to provide a seed position for DCP calculations. A DCP engine may be used with a smaller EKF state size without ambiguity term estimation, with a high rate and with low latency. A DCP engine may use seed information (including position) to determine a present position. If base correction (e.g., pseudorange correction and/or carrier phase correction) is lost, then a most-recent position/velocity/time (PVT) determination may be used as a seed PVT, and new data (e.g., pseudorange, carrier phase, CM0, Doppler) may be used to propagate a PVT determination.

In the direct delta approach to DCP, carrier phase measurements at various times after an initial time are compared to the carrier phase measurement made at the initial time. The observation and the device seed position at an initial time t₀ are buffered, and each time that a measurement is made thereafter, the new information is compared to the buffered to information to determine a delta-position between the time t₀ and the current time. The device position at a later time tᵢ (after the initial time to) may be determined according to

$$\tilde{P} ( {t}_{i} ) = P ( {t}_{0} ) + δ \tilde{p} ( {t}_{i} ) \qquad ( 1 )$$

where \tilde{P} is the device position estimate computed in a direct delta approach, P(t₀) is the device seed position at time t₀, and δ\tilde{p} is the direct delta position between t₀ and tᵢ. If there are no SVs in common between time t₀ and time t₁, then the direct delta approach cannot propagate the position estimate.

In the accumulated delta approach, a most-recent position estimate, and present and most-recent carrier phase measurements are used to determine a present position estimate. There is no need to buffer the initial position estimate or initial carrier phase measurements (beyond use in determining a second position estimate). A position at time tᵢ may be determined according to

$$\hat{P} ( {t}_{i} ) = P ( {t}_{0} ) + {\sum }_{s = 1}^{i} δ \hat{p} ( {t}_{s} ) \qquad ( 2 )$$

where \hat{P} is a device position estimate computed in accumulated delta approach, P(t₀) is the device seed position, and δ\hat{p} is the accumulated delta position between tᵢ and tᵢ₋₁. The accumulated delta approach may perform better than the direct delta approach where eventually there is no common SV between presently-observed SVs and initially-observed SVs, e.g., because while cycle slips may occur on some observed SVs, other SVs may be observed without cycle slips, enabling a position estimate to be determined. In the accumulated delta approach, delta position error present at each position estimate may accumulate, which may eventually become unacceptable (e.g., above a threshold error). GNSS estimation is non-linear, and in the accumulated delta approach, the position error from each step can accumulate. Therefore the determined delta-position between t₀ and tᵢ using the direct delta approach can be different from the value computed using accumulated delta approach, that is

$$δ \tilde{p} ( {t}_{i} ) \neq {\sum }_{s = 1}^{i} δ \hat{p} ( {t}_{s} ) \qquad ( 3 )$$

The positioning engine 260 may be configured to implement a hybrid DCP approach. The hybrid DCP engine may provide a balance between the direct delta DCP approach and the accumulated delta DCP approach. In the hybrid DCP approach, a direct DCP between carrier phase measurements at t₀ every value of tᵢ need not be run. In this way, the hybrid DCP approach may achieve advantages of the accumulated delta approach by allowing position estimate propagation even if no SV is common between an initial observation time and a present observation time. Further, unlike the direct delta approach, less than all raw measurement information determined at an initial time (t₀) may be stored in the hybrid approach. In the hybrid DCP approach, by using the seed position at tᵢ and the carrier phase measurement at t₀, ambiguity values are computed and maintained afterwards. In the hybrid DCP approach, ambiguity may be removed from carrier phase measurements, and ambiguity-removed carrier phase measurements may be used rather than step-wise DCP measurements, which may mitigate delta-position error accumulation. In the hybrid DCP approach, the measurement at tᵢ need not be buffered. By using the seed position at tᵢ and the CP (Carrier Phase) at t₀, ambiguity values may be computed and maintained. At time tᵢ, by removing the maintained ambiguity from the CP at tᵢ, the device position can be computed by using the un-ambiguous CP at tᵢ. In the direct delta approach, the CP measurement at t₀ is buffered, then at time tᵢ, the DCP may be formed by using the differential CP from tᵢ and the CP from t₀, and computing the delta position from time t₀ t₀ time tᵢ. No ambiguity is involved because it is assumed that the CP from t₀ to tᵢ is continuous and that there is no cycle slip.

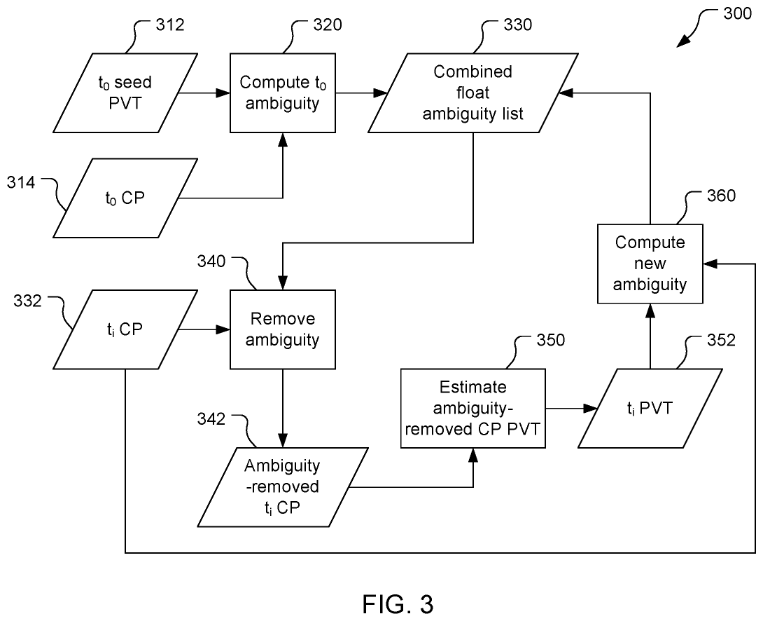

Referring also to FIG. 3, a processing and data flow 300 for hybrid DCP techniques for positioning a mobile device includes the stages shown. The flow 300 is an example only and not limiting. The flow 300 may be altered, e.g., by having stages added, removed, rearranged, combined, performed concurrently, and/or having single stages split into multiple stages. As discussed more fully below, in the flow 300 at an initial time t₀, a combined float ambiguity list may be determined, e.g., based on a seed PVT determination. At a later time, tᵢ, an ambiguity-removed carrier phase (CP) measurement, tᵢ CP, may be used to compute a current PVT determination, tᵢ PVT. One or more, if any, new ambiguities may be computed and the tᵢ PVT and tᵢ CP values may be added to the combined float ambiguity list. In this hybrid DCP engine, delta-position accumulation error may be mitigated by maintaining (e.g., updating) the combined float ambiguity list.

At stage 320, information may be obtained and used to compute an ambiguity for each of one or more combinations of SV and frequency band. For example, as shown, a seed PVT determination 312 and an initial carrier phase measurement 314 may be used to compute ambiguity, although less than all information of the seed PVT determination 312 and the initial carrier phase measurement 314 (e.g., the information discussed below) may be obtained and used to determine the ambiguity. The seed PVT determination 312 may be provided, for example, by the main engine 270 or a fast engine 280 of the positioning engine 260. The seed PVT may, for example, be computed from a most-recent PVT estimate and/or may be determined from low-rate data (e.g., pseudorange, carrier phase CM0, Doppler). The positioning engine 260 may, for example, compute the ambiguity for each of many combinations of satellite and frequency band (e.g., each of multiple signals, with each signal having a unique combination of frequency and SV source from which the signal was transmitted, although multiple signals with different frequencies may be transmitted from a single SV and/or multiple signals may be transmitted with the same frequency from different SVs). A carrier phase measurement may be expressed as

$${ϕ}_{t 0}^{j} = {ρ}_{t 0}^{j} + {T}_{t 0} - d {t}_{t 0}^{j} + {ISTB}_{t 0} + {dTrop}_{t 0}^{j} - {dIono}_{t 0}^{j} + λ ( {N}^{j} + {r}_{t 0} - {s}_{t 0}^{j} ) + {ε}_{{ϕ}_{t 0}}^{j} \qquad ( 4 )$$

where ϕ is a carrier phase measurement (in meters), ρ is a geometry range truth (in meters), T is receiver clock truth (in meters), t0 is an indication of time t₀, j is an indication of the j^{th} SV (i.e., the SV with ID of j), dt is satellite clock residual error (in meters) after-deducting the computed satellite clock value using ephemeris, ISTB is inter/intra system/signal time bias (in meters), dTrop is troposphere residual error (in meters) after applying the model, dIono is ionosphere residual error (in meters) after applying the model, Nis an integer ambiguity (number of cycles), r is an ambiguity receiver fractional bias term (in cycles), s is an ambiguity satellite fractional bias term (in cycles), and ε is a noise and multipath term (in meters). The ρ and T terms are parts of the t₀ PVT computation and, once removed, leave the ambiguity. The positioning engine 260 may compute an ambiguity for the initial time t₀ according to

$${A}_{t 0}^{j} = {ϕ}_{t 0}^{j} - ( {\hat{ρ}}_{t 0}^{j} + {\hat{T}}_{t 0} ) \qquad ( 5 )$$

where \hat{p}ₜ₀^{j} and \hat{T}ₜ₀ are geometry range and receiver clock computed through the seed PVT determination, and will be very close to ρₜ₀^{j} and Tₜ₀ if the seed information is accurate. Consequently, a combined float ambiguity list 330 may be expressed as a lump sum of several items according to

$${A}_{t 0}^{j} = [ - {dt}_{t 0}^{j} + {ISTB}_{t 0} + {dTrop}_{t 0}^{j} - {dIono}_{t 0}^{j} + λ ( {N}^{j} + {r}_{t 0} - {s}_{t 0}^{j} ) ] \qquad ( 6 )$$

This combined float ambiguity list 330 (with each ambiguity being a float (as opposed to an integer) value) may be buffered (e.g., stored in the memory 230) for later use at time tᵢ.

At stage 340, ambiguity stored in the combined float ambiguity list 330 is removed from each corresponding presently-measured carrier phase (CP) measurement of a tᵢ CP 332, which is a set of CP measurements at a present time tᵢ. For example, the positioning engine 260 may produce an ambiguity-removed tᵢ CP 342 (that is an ambiguity-removed CP measurement) by, for those combinations of SV and frequency for which a float ambiguity is stored in the combined float ambiguity list 330, removing the float ambiguity from the carrier phase according to

$${\tilde{ϕ}}_{ti}^{j} = ( {ϕ}_{ti}^{j} - {A}_{t 0}^{j} ) \qquad ( 7 )$$

where ϕₜᵢ^{j} is the measured CP at time tᵢ (i.e., tᵢ CP 332), and it is assumed that values of components of Aₜₒ do not change dramatically between tₒ and tᵢ (e.g., 20 seconds or less), such that the error is not expected to change dramatically (e.g., more than 10 cm). The ambiguity-removed carrier phase measurement at time tᵢ (i.e., ambiguity-removed tᵢ CP 342) may be computed by the positioning engine 260 according to

$${\tilde{ϕ}}_{ti}^{j} \approx {ρ}_{ti}^{j} + {T}_{ti} + {ε}_{{ϕ}_{t i}^{j}} \qquad ( 8 )$$

where \tilde{ϕ}ₜᵢ^{j} is a CP measurement after correction is applied to remove ambiguity. As ambiguity has been removed, estimating ambiguity may be avoided while calculating CP PVT at stage 350, e.g., by the fast engine 280. Equation (8) expressed the ambiguity-removed CP in terms of components including position and time.

At stage 350, the positioning engine 260 may estimate an ambiguity-removed CP PVT determination, tᵢ PVT 352. For example, the fast engine 280 may use the ambiguity-removed tᵢ CP 342 to estimate the ambiguity-removed CP PVT determination, t₌ᵢ PVT 352.

At stage 360, one or more new ambiguities may be computed. For example, the positioning engine 260 may use the tᵢ PVT 352 provided from stage 350 and the tᵢ CP 332 and compute the ambiguity according to

$${A}_{ti}^{k} = {ϕ}_{ti}^{k} - ( {\hat{ρ}}_{ti}^{k} + {\hat{T}}_{ti} ) \qquad ( 9 )$$

where k is an indicator of the k^{th} SV (that first appears at time tᵢ) and where Equation (9) is Equation (5) modified for time tᵢ instead of time t₀. Equation (9) may be used at least for each SV/frequency combination for which an ambiguity does not already exist in the combined float ambiguity list 330. The time value \hat{T}ₜᵢ is an absolute clock value, may be calculated and provided by the fast engine 280 at stage 350, and may be very accurate due to calculating this value based on carrier phase measurement. Any new ambiguity determined at stage 360 may be added to the combined float ambiguity list 330 for future (e.g., at time tᵢ₊₁) use in removing ambiguity at stage 340.

Computer simulations have shown that using hybrid DCP calculations may improve positioning accuracy over time in view of initially-visible SVs becoming non-visible and/or in view of presence of potential accumulated error. For example, it has been shown through simulation that for 10 Hz DCP propagation, for a system that yielded 1.5 m horizontal error over 200 steps applying the accumulated delta approach, using hybrid DCP techniques discussed herein reduced accumulated error to less than 0.5 m.

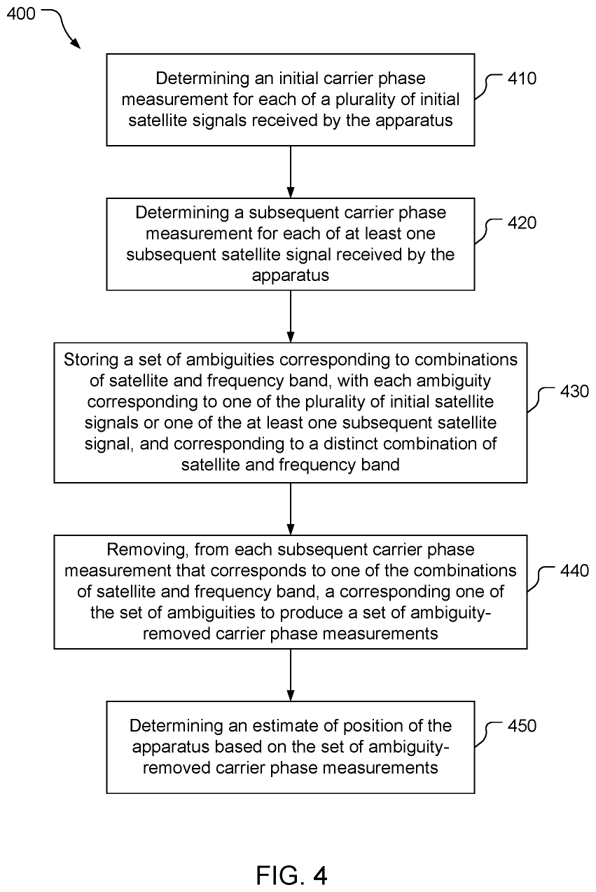

Referring to FIG. 4, with further reference to FIGS. 1-3, a method 400 for estimating position of an apparatus includes the stages shown. The method 400 is, however, an example only and not limiting. The method 400 may be altered, e.g., by having stages added, removed, rearranged, combined, performed concurrently, and/or having single stages split into multiple stages.

At stage 410, the method 400 includes determining an initial carrier phase measurement for each of a plurality of initial satellite signals received by the apparatus. For example, the SPS receiver 240 may receive positioning signals (e.g., the signals 141, 142, 150) from one or more SVs (e.g., the satellites 190, 192), with each signal having a corresponding unique combination of SV source and frequency band. The positioning engine 260 may determine an initial carrier phase measurement for each of the positioning signals. The SPS receiver 240, in combination with the antenna 244, possibly in combination with the processor 210 (possibly in combination with the memory 230), may comprise means for determining the initial carrier phase measurement for each of a plurality of initial satellite signals.

At stage 420, the method 400 includes determining a subsequent carrier phase measurement for each of at least one subsequent satellite signal received by the apparatus. For example, the SPS receiver 240 may receive subsequent positioning signals (e.g., the signals 141, 142, 150) from one or more SVs (e.g., the satellites 190, 192) after receiving the initial satellite signals, with each subsequent positioning signal having a corresponding unique combination of SV source and frequency band. The positioning engine 260 may determine a subsequent carrier phase measurement for each of the subsequent positioning signals. The SPS receiver 240, in combination with the antenna 244, possibly in combination with the processor 210 (possibly in combination with the memory 230), may comprise means for determining the subsequent carrier phase measurement for each of the at least one subsequent satellite signal.

At stage 430, the method 400 includes storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band. For example, the processor 210 may store the combined float ambiguity list 330. The processor 210, possibly in combination with the memory 230, may comprise means for storing the set of ambiguities.

At stage 440, the method 400 includes removing, from each subsequent carrier phase measurement that corresponds to one of the combinations of satellite and frequency band, a corresponding one of the set of ambiguities to produce a set of ambiguity-removed carrier phase measurements. For example, at stage 340 the processor 210 may remove the ambiguity from each corresponding carrier phase measurement of the tᵢ CP 332 (each carrier phase measurement of the tᵢ CP 332 for which an ambiguity for the same SV and frequency is stored in the list 330). The processor 210, possibly in combination with the memory 230, may comprise means for removing a corresponding one of the set of ambiguities.

At stage 450, the method 400 includes determining an estimate of position of the apparatus based on the set of ambiguity-removed carrier phase measurements. For example, the processor 210 (e.g., the fast engine 280) may, at stage 350, estimate an ambiguity-removed CP PVT, tᵢ PVT 352, including position. The processor 210, possibly in combination with the memory 230, may comprise means for determining the estimate of the position of the apparatus based on the set of ambiguity-removed carrier phase measurements.

Implementations of the method 400 may include one or more of the following features. In an example implementation, the estimate of position of the apparatus is a subsequent estimate of position of the apparatus, and the method 400 further includes determining each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals. For example, the processor 210 may determine the combined float ambiguity list 330 based on determining, at stage 320, the to ambiguity based on the to seed PVT, which the device 200 may receive and/or determine. The processor 210, possibly in combination with the memory 230, possibly in combination with the transceiver 220, may comprise means for determining each ambiguity. In a further example implementation, determining each ambiguity corresponding to one of the plurality of initial satellite signals includes subtracting a geometry range and a receiver clock truth from a corresponding initial carrier phase measurement, the geometry range and the receiver clock truth being based on the initial estimate, of position of the apparatus, velocity of the apparatus, and time. For example, the processor 210, e.g., the main engine 270, may compute each ambiguity according to Equation (5). The processor 210, possibly in combination with the memory 230, may comprise means for subtracting the geometry range and receiver clock truth from a corresponding initial carrier phase measurement.

Also or alternatively, implementations of the method 400 may include one or more of the following features. In an example implementation, the estimate of position of the apparatus is a portion of a subsequent estimate, of position of the apparatus, of velocity of the apparatus, and time, and the method further comprises determining each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal. For example, the processor 210 may determine, at stage 360, the float ambiguity for one or more carrier phase measurements (e.g., corresponding to an SV/frequency combination not present in the combined float ambiguity list 330) based on estimating, at stage 350, the ambiguity-removed CP PVT, tᵢ PVT 352. The processor 210, possibly in combination with the memory 230, may comprise means for determining each ambiguity corresponding to one of the at least one subsequent satellite signal. In a further example implementation, determining each ambiguity corresponding to one of the at least one subsequent satellite signal comprises subtracting a geometry range and a receiver clock truth from a corresponding subsequent carrier phase measurement, the geometry range and the receiver clock truth being based on the subsequent estimate, of position of the apparatus, of velocity of the apparatus, and time. For example, the processor 210, e.g., the main engine 270, may compute each ambiguity (corresponding to a subsequent satellite signal) according to Equation (9). The processor 210, possibly in combination with the memory 230, may comprise means for subtracting the geometry range and receiver clock truth from a corresponding subsequent carrier phase measurement.

Also or alternatively, implementations of the method 400 may include one or more of the following features. In an example implementation, the set of ambiguities comprises a float ambiguity list.

### Implementation Examples

Implementation examples are provided in the following numbered clauses.

Clause 1. An apparatus comprising:
at least one receiver configured to transduce wireless signals into guided signals;
at least one memory;
at least one processor, communicatively coupled to the at least one receiver and the at least one memory, configured to:
   determine an initial carrier phase measurement for each of a plurality of initial satellite signals received by the at least one receiver;
   determine a subsequent carrier phase measurement for each of at least one subsequent satellite signal received by the at least one receiver;
   store a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band;
   remove, from each subsequent carrier phase measurement that corresponds to one of the combinations of satellite and frequency band, a corresponding one of the set of ambiguities to produce a set of ambiguity-removed carrier phase measurements; and
   determine an estimate of position of the apparatus based on the set of ambiguity-removed carrier phase measurements.

Clause 2. The apparatus of clause 1, wherein the estimate of position of the apparatus is a subsequent estimate of position of the apparatus, and the at least one processor is configured to determine each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals.

Clause 3. The apparatus of clause 2, wherein the at least one processor is configured to determine each ambiguity corresponding to one of the plurality of initial satellite signals by subtracting a geometry range and a receiver clock truth from a corresponding initial carrier phase measurement, the geometry range and the receiver clock truth being based on the initial estimate, of position of the apparatus, velocity of the apparatus, and time.

Clause 4. The apparatus of clause 1, wherein the estimate of position of the apparatus is a portion of a subsequent estimate, of position of the apparatus, of velocity of the apparatus, and time, and the at least one processor is configured to determine each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal.

Clause 5. The apparatus of clause 4, wherein the at least one processor is configured to determine each ambiguity corresponding to one of the at least one subsequent satellite signal by subtracting a geometry range and a receiver clock truth from a corresponding subsequent carrier phase measurement, the geometry range and the receiver clock truth being based on the subsequent estimate, of position of the apparatus, of velocity of the apparatus, and time.

Clause 6. The apparatus of clause 1, wherein the set of ambiguities comprises a float ambiguity list.

Clause 7. A method, for estimating position of an apparatus, comprising:
determining an initial carrier phase measurement for each of a plurality of initial satellite signals received by the apparatus;
determining a subsequent carrier phase measurement for each of at least one subsequent satellite signal received by the apparatus;
storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band;
removing, from each subsequent carrier phase measurement that corresponds to one of the combinations of satellite and frequency band, a corresponding one of the set of ambiguities to produce a set of ambiguity-removed carrier phase measurements; and
determining an estimate of position of the apparatus based on the set of ambiguity-removed carrier phase measurements.

Clause 8. The method of clause 7, wherein the estimate of position of the apparatus is a subsequent estimate of position of the apparatus, and the method further comprises determining each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals.

Clause 9. The method of clause 8, wherein determining each ambiguity corresponding to one of the plurality of initial satellite signals comprises subtracting a geometry range and a receiver clock truth from a corresponding initial carrier phase measurement, the geometry range and the receiver clock truth being based on the initial estimate, of position of the apparatus, velocity of the apparatus, and time.

Clause 10. The method of clause 7, wherein the estimate of position of the apparatus is a portion of a subsequent estimate, of position of the apparatus, of velocity of the apparatus, and time, and the method further comprises determining each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal.

Clause 11. The method of clause 10, wherein determining each ambiguity corresponding to one of the at least one subsequent satellite signal comprises subtracting a geometry range and a receiver clock truth from a corresponding subsequent carrier phase measurement, the geometry range and the receiver clock truth being based on the subsequent estimate, of position of the apparatus, of velocity of the apparatus, and time.

Clause 12. The method of clause 7, wherein the set of ambiguities comprises a float ambiguity list.

Clause 13. An apparatus comprising:
means for determining an initial carrier phase measurement for each of a plurality of initial satellite signals received by the apparatus;
means for determining a subsequent carrier phase measurement for each of at least one subsequent satellite signal received by the apparatus;
means for storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band;
means for removing, from each subsequent carrier phase measurement that corresponds to one of the combinations of satellite and frequency band, a corresponding one of the set of ambiguities to produce a set of ambiguity-removed carrier phase measurements; and
means for determining an estimate of position of the apparatus based on the set of ambiguity-removed carrier phase measurements.

Clause 14. The apparatus of clause 13, wherein the estimate of position of the apparatus is a subsequent estimate of position of the apparatus, and the apparatus further comprises means for determining each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals.

Clause 15. The apparatus of clause 14, wherein the means for determining each ambiguity corresponding to one of the plurality of initial satellite signals comprise means for subtracting a geometry range and a receiver clock truth from a corresponding initial carrier phase measurement, the geometry range and the receiver clock truth being based on the initial estimate, of position of the apparatus, velocity of the apparatus, and time.

Clause 16. The apparatus of clause 13, wherein the estimate of position of the apparatus is a portion of a subsequent estimate, of position of the apparatus, of velocity of the apparatus, and time, and the apparatus further comprises means for determining each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal.

Clause 17. The apparatus of clause 16, wherein the means for determining each ambiguity corresponding to one of the at least one subsequent satellite signal comprise means for subtracting a geometry range and a receiver clock truth from a corresponding subsequent carrier phase measurement, the geometry range and the receiver clock truth being based on the subsequent estimate, of position of the apparatus, of velocity of the apparatus, and time.

Clause 18. The apparatus of clause 13, wherein the set of ambiguities comprises a float ambiguity list.

Clause 19. A non-transitory, processor-readable storage medium comprising processor-readable instructions to cause a processor of an apparatus to:
determine an initial carrier phase measurement for each of a plurality of initial satellite signals received by the apparatus;
determine a subsequent carrier phase measurement for each of at least one subsequent satellite signal received by the apparatus;
store a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band;
remove, from each subsequent carrier phase measurement that corresponds to one of the combinations of satellite and frequency band, a corresponding one of the set of ambiguities to produce a set of ambiguity-removed carrier phase measurements; and
determine an estimate of position of the apparatus based on the set of ambiguity-removed carrier phase measurements.

Clause 20. The non-transitory, processor-readable storage medium of clause 19, wherein the estimate of position of the apparatus is a subsequent estimate of position of the apparatus, and the non-transitory, processor-readable storage medium further comprises processor-readable instructions to cause the processor to determine each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals.

Clause 21. The non-transitory, processor-readable storage medium of clause 20, wherein the processor-readable instructions to cause the processor to determine each ambiguity corresponding to one of the plurality of initial satellite signals comprise processor-readable instructions to cause the processor to subtract a geometry range and a receiver clock truth from a corresponding initial carrier phase measurement, the geometry range and the receiver clock truth being based on the initial estimate, of position of the apparatus, velocity of the apparatus, and time.

Clause 22. The non-transitory, processor-readable storage medium of clause 19, wherein the estimate of position of the apparatus is a portion of a subsequent estimate, of position of the apparatus, of velocity of the apparatus, and time, and the non-transitory, processor-readable storage medium further comprises processor-readable instructions to cause the processor to determine each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal.

Clause 23. The non-transitory, processor-readable storage medium of clause 22, wherein the processor-readable instructions to cause the processor to determine each ambiguity corresponding to one of the at least one subsequent satellite signal comprise processor-readable instructions to cause the processor to subtract a geometry range and a receiver clock truth from a corresponding subsequent carrier phase measurement, the geometry range and the receiver clock truth being based on the subsequent estimate, of position of the apparatus, of velocity of the apparatus, and time.

Clause 24. The non-transitory, processor-readable storage medium of clause 19, wherein the set of ambiguities comprises a float ambiguity list.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

The invention claimed is:

1. An apparatus comprising:
at least one receiver configured to transduce wireless signals into guided signals;
at least one memory;
at least one processor, communicatively coupled to the at least one receiver and the at least one memory, configured to:
determine an initial carrier phase measurement for each of a plurality of initial satellite signals received by the at least one receiver;
determine a subsequent carrier phase measurement for each of at least one subsequent satellite signal received by the at least one receiver;
store a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band;
remove, from each subsequent carrier phase measurement that corresponds to one of the combinations of satellite and frequency band, a corresponding one of the set of ambiguities to produce a set of ambiguity-removed carrier phase measurements; and
determine an estimate of position of the apparatus based on the set of ambiguity-removed carrier phase measurements.

2. The apparatus of claim 1, wherein the estimate of position of the apparatus is a subsequent estimate of position of the apparatus, and the at least one processor is configured to determine each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals.

3. The apparatus of claim 2, wherein the at least one processor is configured to determine each ambiguity corresponding to one of the plurality of initial satellite signals by subtracting a geometry range and a receiver clock truth from a corresponding initial carrier phase measurement, the geometry range and the receiver clock truth being based on the initial estimate, of position of the apparatus, velocity of the apparatus, and time.

4. The apparatus of claim 1, wherein the estimate of position of the apparatus is a portion of a subsequent estimate, of position of the apparatus, of velocity of the apparatus, and time, and the at least one processor is configured to determine each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal.

5. The apparatus of claim 4, wherein the at least one processor is configured to determine each ambiguity corresponding to one of the at least one subsequent satellite signal by subtracting a geometry range and a receiver clock truth from a corresponding subsequent carrier phase measurement, the geometry range and the receiver clock truth being based on the subsequent estimate, of position of the apparatus, of velocity of the apparatus, and time.

6. The apparatus of claim 1, wherein the set of ambiguities comprises a float ambiguity list.

7. A method, for estimating position of an apparatus, comprising:
determining an initial carrier phase measurement for each of a plurality of initial satellite signals received by the apparatus;
determining a subsequent carrier phase measurement for each of at least one subsequent satellite signal received by the apparatus;
storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band;
removing, from each subsequent carrier phase measurement that corresponds to one of the combinations of satellite and frequency band, a corresponding one of the set of ambiguities to produce a set of ambiguity-removed carrier phase measurements; and
determining an estimate of position of the apparatus based on the set of ambiguity-removed carrier phase measurements.

8. The method of claim 7, wherein the estimate of position of the apparatus is a subsequent estimate of position of the apparatus, and the method further comprises determining each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals.

9. The method of claim 8, wherein determining each ambiguity corresponding to one of the plurality of initial satellite signals comprises subtracting a geometry range and a receiver clock truth from a corresponding initial carrier phase measurement, the geometry range and the receiver clock truth being based on the initial estimate, of position of the apparatus, velocity of the apparatus, and time.

10. The method of claim 7, wherein the estimate of position of the apparatus is a portion of a subsequent estimate, of position of the apparatus, of velocity of the apparatus, and time, and the method further comprises determining each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal.

11. The method of claim 10, wherein determining each ambiguity corresponding to one of the at least one subsequent satellite signal comprises subtracting a geometry range and a receiver clock truth from a corresponding subsequent carrier phase measurement, the geometry range and the receiver clock truth being based on the subsequent estimate, of position of the apparatus, of velocity of the apparatus, and time.

12. The method of claim 7, wherein the set of ambiguities comprises a float ambiguity list.

13. An apparatus comprising:
means for determining an initial carrier phase measurement for each of a plurality of initial satellite signals received by the apparatus;
means for determining a subsequent carrier phase measurement for each of at least one subsequent satellite signal received by the apparatus;
means for storing a set of ambiguities corresponding to combinations of satellite and frequency band, with each ambiguity corresponding to one of the plurality of initial satellite signals or one of the at least one subsequent satellite signal, and corresponding to a distinct combination of satellite and frequency band;
means for removing, from each subsequent carrier phase measurement that corresponds to one of the combinations of satellite and frequency band, a corresponding one of the set of ambiguities to produce a set of ambiguity-removed carrier phase measurements; and
means for determining an estimate of position of the apparatus based on the set of ambiguity-removed carrier phase measurements.

14. The apparatus of claim 13, wherein the estimate of position of the apparatus is a subsequent estimate of position of the apparatus, and the apparatus further comprises means for determining each ambiguity, of the set of ambiguities, corresponding to one of the plurality of initial satellite signals based on the initial carrier phase measurement corresponding to the one of the plurality of initial satellite signals and based on an initial estimate, of position of the apparatus, velocity of the apparatus, and time, that is based on the initial carrier phase measurement for each of the plurality of initial satellite signals.

15. The apparatus of claim 14, wherein the means for determining each ambiguity corresponding to one of the plurality of initial satellite signals comprise means for subtracting a geometry range and a receiver clock truth from a corresponding initial carrier phase measurement, the geometry range and the receiver clock truth being based on the initial estimate, of position of the apparatus, velocity of the apparatus, and time.

16. The apparatus of claim 13, wherein the estimate of position of the apparatus is a portion of a subsequent estimate, of position of the apparatus, of velocity of the apparatus, and time, and the apparatus further comprises means for determining each ambiguity, of the set of ambiguities, corresponding to one of the at least one subsequent satellite signal based on the subsequent carrier phase measurement corresponding to the one of the at least one subsequent satellite signal and based on the subsequent estimate, of position of the apparatus, of velocity of the apparatus, and time, that is based on the subsequent carrier phase measurement for each of the at least one subsequent satellite signal.

17. The apparatus of claim 16, wherein the means for determining each ambiguity corresponding to one of the at least one subsequent satellite signal comprise means for subtracting a geometry range and a receiver clock truth from a corresponding subsequent carrier phase measurement, the geometry range and the receiver clock truth being based on the subsequent estimate, of position of the apparatus, of velocity of the apparatus, and time.

18. The apparatus of claim 13, wherein the set of ambiguities comprises a float ambiguity list.
